(19) United States
(12) Patent Application Publication
(10) Pub. No.: US 2022/0002111 A1
(43) Pub. Date: Jan. 6, 2022

(54) METHOD FOR CHARGING A PROCESSING DEVICE WITH A PROFILE STRAND TO BE FED TO THE PROCESSING DEVICE

(71) Applicant: CQLT SAARGUMMI TECHNOLOGIES S.À.R.L., Remich (LU)

(72) Inventor: Jörg GEBER, Beckingen (DE)

(21) Appl. No.: 17/293,514

(22) PCT Filed: Sep. 17, 2019
(86) PCT No.: PCT/EP2019/000268

§ 371 Date: May 13, 2021

(30) Foreign Application Priority Data
Dec. 11, 2018 (DE) 10 2018 131 673.9

(51) Int. Cl. B65H 49/30; B65H 49/32; B60J 10/00

(52) U.S. Cl. CPC B65H 49/305; B65H 2701/3913; B60J 10/45; B65H 49/328

(57) ABSTRACT

A method for charging a processing device with a profile strand which is to be fed to the processing device. The processing device, by severing strand portions and connecting the strand portions to a vehicle body, processes to form seals or edge protection strips on the vehicle body. The profile strand is fed in the strand longitudinal direction from a delivery unit used to transport the profile strand to the processing location while being unwound from a winding contained in the delivery unit. The profile strand is either unwound as a right-hand profile, which is to be applied to the vehicle body on the right, beginning with one of the two strand ends, or as a left-hand profile, which is to be applied to the vehicle body on the left, beginning with the other strand end. A delivery unit and a winding holder are provided for carrying out the method.

The invention relates to a method for charging a processing device with a profile strand which is to be fed to the processing device and which the processing device, by severing strand portions and connecting the strand portions to a vehicle body, automatically processes to form seals or edge protection strips on the vehicle body, wherein the profile strand is fed in the strand longitudinal direction to the processing device from a delivery unit transported to the processing location while being unwound from a winding contained in the delivery unit.

The invention further relates to a delivery unit and a winding holder for carrying out the method.

A method of the type mentioned in the introduction is disclosed in EP 1 733 889 B2. Delivery units, which are assembled by the strand material manufacturer for carrying out the method, contain sealing profile strands which, according to FIG. 6, are extruded in pairs with an easily detachable connecting bridge 25. According to FIG. 7 the profile strands which are fed from the extrusion system are severed from one another and then wound onto a roller. The delivery units produced thereby are respectively able to be used only for forming a seal on the right-hand side or on the left-hand side of the vehicle body (without rewinding the profile strand or changing the application process of the severed strand portions). The delivery units thus have to be labelled according to their application.

The object of the invention is to simplify the automatic production of seals or edge protection strips on vehicle bodies, said seals or edge protection strips being made from strand material fed from a delivery unit.

This object is achieved in a method of the type mentioned in the introduction by the profile strand being either unwound as a right-hand profile, which is to be applied to the vehicle body on the right, beginning with one of the two strand ends, or as a left-hand profile, which is to be applied to the vehicle body on the left, beginning with the other strand end.

Both a right-hand and a left-hand vehicle side may be provided with seals and/or edge protection strips by means of the selective unwinding, which begins with the one or the other strand end from one and the same delivery unit. No labelling is required relative to the application. The delivery units only contain information regarding the strand end at which a right-hand profile is able to be unwound and the strand end at which a left-hand profile is able to be unwound.

For forming the winding at the strand material manufacturer, the profile strand may be arranged in axially or radially successive layers relative to a winding axis.

For forming the winding, the profile strand is preferably arranged in layers, in spirals which are concentric to the winding axis. By exposing a winding end, therefore, the strand may be guided out of the delivery unit, by being unwound in layers in the axial direction, while the unwound profile strand is moved in the strand longitudinal direction.

For unwinding and feeding the profile strand to the processing unit, therefore, the winding is preferably rotated about the winding axis. Expediently, this rotation is carried out by rotating the entire delivery unit, for example on a turntable.

It goes without saying that in such a case the winding axis preferably runs vertically and the winding axis is oriented toward the rotational axis of the turntable.

For selecting the right-hand or left-hand profile, the winding may be rotated by 180° about an axis perpendicular to the winding axis.

The delivery unit according to the invention comprises a winding, which is formed by a single profile strand which is made of elastomer material and which comprises elastomer material, and comprises a winding holder receiving the winding. According to the invention the winding is accessible in the winding holder such that the profile strand may be selectively unwound from the winding, beginning with the one or the other strand end, and may be guided out of the winding holder while being moved in the strand longitudinal direction.

The winding preferably has axially or radially successive layers relative to the winding axis.

The two ends of the profile strand are expediently arranged at opposing radial ends of the winding or both ends are arranged at the same axial end of the winding.

In a preferred embodiment of the invention, the winding holder has front plates which are arranged at the ends of the winding and which are preferably connected together via a core which is coaxial to the winding axis.

The winding holder may have movable and/or removable parts for making the winding accessible. In particular, the front plates may have movable, preferably pivotable, parts at one axial end for exposing the winding.

Accordingly, the holder according to the invention for receiving and for transporting a winding, which is made from a profile strand preferably comprising an elastomer material, comprises a coil with front plates and a core connecting the front plates, wherein the front plates are divided and preferably have pivotable parts.

Expediently, the pivotable parts are articulated to a frame holder for the coil.

The pivotable parts are preferably half parts.

The parts may be connected by connecting tabs which provide the divided front plates as a whole with sufficient rigidity.

The invention is described in more detail hereinafter with reference to exemplary embodiments and the accompanying drawings relating to one of these exemplary embodiments, in which:

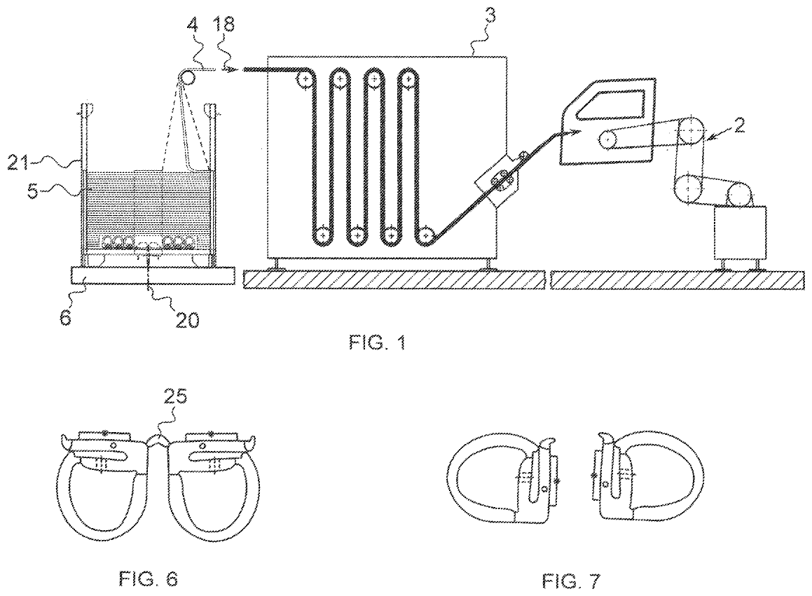

FIG. 1 shows a system for manufacturing seals on vehicle bodies by feeding endless strand material,

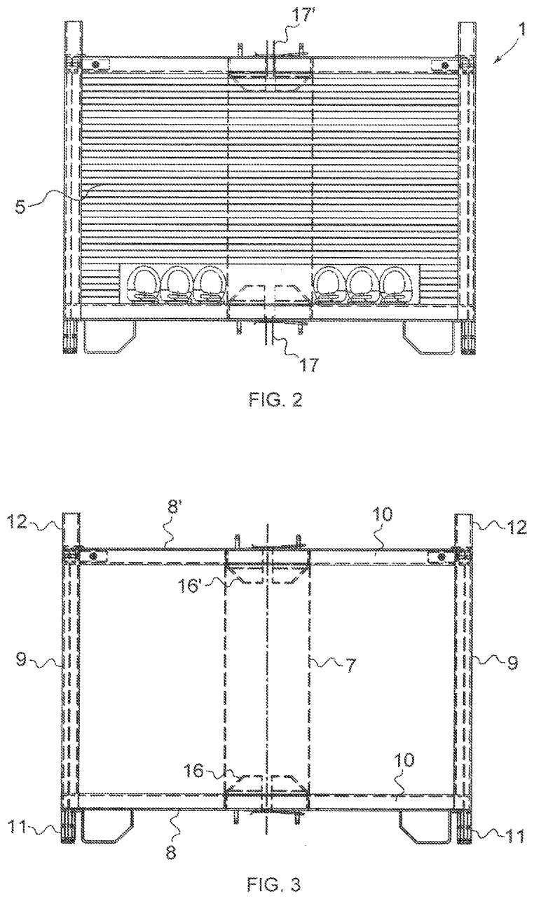

FIG. 2 shows a delivery unit according to the invention used in the system of FIG. 1 and containing a winding made of strand material,

FIG. 3 shows the delivery unit of FIG. 2 without a winding,

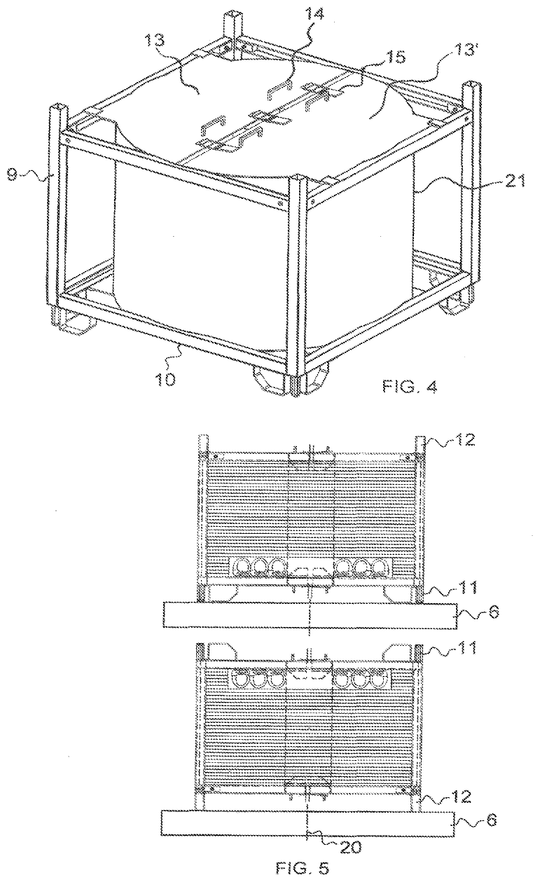

FIG. 4 shows the delivery unit of FIG. 2 in a perspective view,

FIG. 5 shows the delivery unit of FIG. 2 in different arrangements on a turntable, and

FIGS. 6 and 7 show cross-sectional views of profile strands for describing the problem achieved by the invention.

A unit 1 delivered by a manufacturer of profile strands is a component of a production system used by a vehicle manufacturer which automatically forms seals or edge protection strips on a vehicle body, for example on a vehicle door 2. The production system comprises a processing device 3 to which a profile strand 4 which is removed from the delivery unit 1 and which comprises elastomer material is fed as an endless strand (length greater than 1000 m). The processing device 3 severs strand portions from the endless strand and connects them subsequently, previously or in the meantime to the vehicle door 2.

The strand 4 is arranged in the delivery unit 1 in the form of a winding 5. For the unwinding thereof, the delivery unit 1 is rotated in its entirety by a turntable 6 about a vertical axis 20.

The delivery unit 1 shown separately in FIG. 2 comprises, in addition to the aforementioned winding 5, a winding holder which in the example shown has a cylindrical core 7, a cylindrical outer wall 21 which is coaxial to the core and front plates 8 and 8′ connected to the cylindrical core 7. The delivery unit 1 further comprises a frame with four vertical support bars 9 and eight horizontal support bars 10. In each case a foot part 11 is located at the lower four corners of the frame. Foot parts 12 are formed in each case at the upper corners of the frame by extensions of the vertical bars 9. The delivery units are able to be stacked, wherein the foot parts 12 of a lower frame engage in each case in corner recesses in the foot parts 11 of an upper frame.

As may be identified in particular in FIG. 4, the front plates 8, 8′ are divided and half parts 13, 13′ are pivotably articulated to opposing horizontal bars 10 of the frame. Four handles 14 permit the half parts 13, 13′ to be pivoted in a simple manner. Three closure tabs 15 ensure a rigid connection of the half parts 13, 13′ and thus as a whole sufficient rigidity of the front plates 8, 8′ formed by the half parts.

As may be identified in particular in FIG. 3, in each case the front plates 8, 8′ on the inner face are connected to a (divided) cone 16, 16′, which transitions into a cylindrical end part and in each case engages non-positively in the core 7 of hollow configuration, so that the core 7 is fixedly connected to the front plates 8, 8′.

For assembling the delivery unit 1 at the manufacturer of the profile strand 4 forming the winding 5, the profile strand 4, the length thereof for example being 1500 m, is deposited by feeding spiral, axially successive layers on the inner face of one of the front plates 8, 8′. To this end, the frame with the winding holder is rotated in its entirety about the cylinder axis of the core 7 by means of a turntable, as is shown in FIG. 1, and the profile strand 4, which is fed by being moved in the strand longitudinal direction, is slidably guided alternately from inside to outside and from outside to inside by being deflected in spirals which are concentric to the core 7 by a robot arm, for example. If the designated external diameter of the winding defined by the cylindrical outer wall 21 is reached, the guide movement of the robot arm in each case is reversed until the internal diameter of the winding determined by the diameter of the core 7 is reached. In this manner, the axially successive layers of the wound profile strand 4 are produced in a spiral shape.

At the start of the formation of the winding, care has to be taken that the relevant strand end 17 of the profile strand 4 is exposed and is able to be gripped for the unwinding process. In the same manner when the winding is complete, care has to be taken that a grippable strand end 17′ also protrudes from the other winding end.

The delivery unit 1 thus completed is delivered to the vehicle manufacturer, where it is a component of the production system described with reference to FIG. 1.

Depending on whether, for example, seals for right-hand or left-hand doors 2 are to be produced, the delivery unit 1 is either deposited with the feet 11 or the feet 12 on the turntable 6. After opening the closure tabs 15, the half parts 13, 13′ of the relevant front plate 8 and/or 8′ according to FIG. 1 are pivoted upwardly so that the winding 5 is accessible. A connection is made to the processing device 3 via the relevant protruding end 17 and/or 17′, wherein the processing device 3 a pulling device, not shown, exerts a pulling force on the strand 4 according to the arrow 18.

It goes without saying that the processing device 3 may guide the profile strand 4 via buffer loops, it being possible thereby to compensate for the resulting variable strand withdrawal speeds in the strand longitudinal direction during the unwinding process (at a constant rotational speed of the turntable 6).

It goes without saying that the core 7 does not need to be configured as a complete hollow cylinder but could be configured simply by support bars arranged so as to correspond to the lateral surface thereof. In the last case, the empty delivery unit may be assembled in a space-saving manner for efficient return transport.

1-15. (canceled)

16. A method for charging a processing device with a profile strand which is to be fed to the processing device and which the processing device, by severing strand portions and connecting the strand portions to a vehicle body, automatically processes to form seals or edge protection strips on the vehicle body, the method comprising the steps of: feeding the profile strand in a strand longitudinal direction to the processing device from a delivery unit transported to a processing location while being unwound from a winding contained in the delivery unit, wherein
the profile strand is either unwound as a right-hand profile, which is to be applied to the vehicle body on the right, beginning with one of two strand ends, or as a left-hand profile, which is to be applied to the vehicle body on the left, beginning with the other strand end.

17. The method according to claim 16, including forming the winding by arranging the profile strand in axially or radially successive layers relative to a winding axis.

18. The method according to claim 17, including arranging the profile strand in layers in spirals that are concentric to the winding axis.

19. The method according to claim 17, including rotating the winding about the winding axis for unwinding and feeding the profile strand to the processing device.

20. The method according to claim 19, including selecting the right-hand or left-hand profile by rotating the winding 180° about an axis perpendicular to the winding axis.

21. A delivery unit, comprising: a winding formed by a single profile strand of elastomer material; and a winding holder that holds the winding so that the winding is accessible in the winding holder in order to unwind the profile strand selectively from the winding, beginning with a first or a second strand end, and to guide the profile strand out of the winding holder while being moved in a strand longitudinal direction.

22. The delivery unit according to claim 21, wherein the winding has axially or radially successive layers relative to a winding axis.

23. The delivery unit according to claim 22, wherein the two ends of the profile strand are arranged at opposing axial ends of the winding or both ends are arranged at a common axial end of the winding.

24. The delivery unit according to claim 22, wherein the winding holder has front plates arranged at axial ends of the winding.

25. The delivery unit according to claim 24, wherein the front plates are connected together via a core that is coaxial to the winding axis.

26. The delivery unit according to claim 21, wherein the winding holder has movable and/or removable parts for making the winding accessible.

27. The delivery unit according to claim 24, wherein the front plates have movable parts selectively at one axial end for exposing the winding.

28. The delivery unit according to claim 27, wherein the movable parts are pivotable parts.

29. A holder for receiving and for transporting a winding, which is made from a profile strand comprising an elastomer material, comprising: a spool having a core and a front plate at each end of the core, wherein at least one of the front plates is removable so as to expose the winding at one axial end, or has pivotable parts for exposing the winding.

30. The holder according to claim 29, wherein the pivotable parts are pivotably movably connected to a frame receiving the spool.

31. The holder according to claim 29, wherein the pivotable parts are half parts.

32. The holder according to claim 29, wherein the core is hollow and the front plates in each case engage non-positively and/or positively in the core.
